(19) United States
(12) Patent Application Publication
(10) Pub. No.: US 2026/0303372 A1
(43) Pub. Date: Oct. 1, 2026

(54) HYDROGEN FUELING COMMUNICATION METHOD APPLYING PKI-BASED SECURITY, AND DEVICE USING SAME

(71) Applicants: Hyundai Motor Company, Seoul (KR); Kia Corporation, Seoul (KR); MYONGJI UNIVERSITY INDUSTRY AND ACADEMIA COOPERATION FOUNDATION, Yongin-si, Gyeonggi-do (KR)

(72) Inventor: Min Ho SHIN, Yongin-si, Gyeonggi-do (KR)

(21) Appl. No.: 19/475,981

(22) PCT Filed: Apr. 19, 2024
(86) PCT No.: PCT/KR2024/005323

§ 371 Date: Oct. 16, 2025

(30) Foreign Application Priority Data
Apr. 19, 2023 (KR) 10-2023-0051493

(51) Int. Cl. H04L 9/32

(52) U.S. Cl. CPC H04L 9/3268; H04L 9/321

(57) ABSTRACT

The hydrogen fueling communication method between a hydrogen fueled mobility and a hydrogen fueling operator (HFO) included in hydrogen infrastructure, performed by the HFO, comprises the steps of: receiving, from an upper route server, a first subordinate certificate including a signature value and signed information obtained by signing a public key and identification information of a first subordinate certification authority of the HFO with a private key of the upper root server; generating a second subordinate certificate including a signature value and signed information obtained by signing a public key and identification information of a second subordinate certification authority with a private key of the first subordinate certification authority; and issuing, to a dispenser, a dispenser leaf certificate including a signature value and signed information obtained by signing the public key and identification information of the dispenser with the private key of the second subordinate certification authority.

### TECHNICAL FIELD

The present disclosure relates to a communication interface security method and apparatus between a vehicle and a grid, and more particularly, to a hydrogen fuel supply communication method between a hydrogen infrastructure and hydrogen-fueled mobility, to which public key infrastructure (PKI)-based security is applied, and an apparatus using the hydrogen fuel supply communication method.

### BACKGROUND ART

The hydrogen-fueled mobility refers to mobility that uses hydrogen as an energy source or fuel to generate electric energy, which is used to drive an electric motor. The hydrogen-fueled mobility includes hydrogen vehicles, hydrogen electric vehicles, industrial trucks, trains, ships, aircraft, aerial mobility, or the like, and encompasses all devices that generate electric energy using hydrogen as fuel and are driven by the generated electric energy. In the case of vehicles, the hydrogen-fueled mobility may be broadly classified into hydrogen electric vehicles and hydrogen fueled vehicles.

The hydrogen electric vehicle refers to a zero-emission vehicle that operates using electric energy generated by a reaction between high-pressure hydrogen stored in the vehicle and air from the atmosphere. The hydrogen electric vehicle is also referred to as a fuel cell electric vehicle (FCEV), or simply a hydrogen vehicle. Most hydrogen electric vehicles use a fuel cell system that utilizes hydrogen as an energy source to generate electricity, and the generated electricity is used to drive the motor. In a hydrogen electric vehicle, only pure water (H₂O) is emitted during the electricity generation process, and the vehicle is also capable of removing ultrafine dust from the atmosphere during operation, making the hydrogen electric vehicle a promising eco-friendly mobility of the future.

Meanwhile, the hydrogen fueled car is a vehicle that uses hydrogen as fuel, but unlike the hydrogen electric vehicle, the hydrogen fueled car directly combusts hydrogen in an internal combustion engine (ICE) to generate heat, which is then used to drive the vehicle's electric motor. The hydrogen fueling method for hydrogen fueled vehicles is not significantly different from that for hydrogen electric vehicles.

The above-described hydrogen-fueled mobility is receiving widespread attention as a technology with potential for application across various industries due to the facts that hydrogen, as a fuel, is infinite on Earth, and the energy generation process is environmentally friendly.

Meanwhile, the hydrogen-fueled mobility or the user thereof needs to fill the hydrogen tank of the hydrogen-fueled mobility with hydrogen gas at a hydrogen fueling station that provides hydrogen fuel supply services, and pay the hydrogen fueling cost. In particular, hydrogen fuel supply processes, control techniques, or protocols therefor are being automated through computing techniques, and in this atmosphere of automation, the importance of security in hydrogen fuel supply communication between the hydrogen infrastructure and the hydrogen-fueled mobility is increasing.

Accordingly, there is a need for a method capable of effectively performing security in hydrogen fuel supply communication between the hydrogen infrastructure and the hydrogen-fueled mobility.

### DISCLOSURE

### Technical Problem

The present disclosure has been devised to meet the demands of the above-described conventional technologies, and an object of the present disclosure is to provide a hydrogen fuel supply communication method that applies public key infrastructure (PKI)-based security to hydrogen fuel supply communication between a hydrogen infrastructure and hydrogen-fueled mobility.

Another object of the present disclosure is to provide an apparatus that enables unfamiliar entities to effectively verify their identities in hydrogen fuel supply communication by using the above-described hydrogen fuel supply communication method.

Still another object of the present disclosure is to provide a hydrogen fuel supply communication method and an apparatus using the hydrogen fuel supply communication method, which apply PKI-based security and utilize cross-certificates in hydrogen fuel supply communication to effectively extend trust relationships to unfamiliar entities.

### Technical Solution

A hydrogen fueling communication method by a hydrogen fueling operator (HFO) according to an exemplary embodiment, comprises: receiving, from an upper root server, a first subordinate certificate that includes a signature value and signed information, the signature value generated by signing a public key and identification information of a first subsequent certificate authority of the HFO using a private key of the upper root server; generating, by the first subsequent certificate authority, a second subordinate certificate that includes a signature value and signed information, the signature value generated by signing a public key and identification information of a second subsequent certificate authority using the private key of the first subsequent certificate authority; and issuing, by the second subsequent certificate authority, a dispenser leaf certificate that includes a signature value and signed information, the signature value generated by signing a public key and identification information of a dispenser using the private key of the second subsequent certificate authority.

The hydrogen fueling communication method may further comprise performing a handshake of transport layer security (TLS) with at least one entity of a hydrogen infrastructure to which the hydrogen fueling operator belongs.

The hydrogen fueling communication method may further comprise generating, by the dispenser using a private key thereof, a dispenser certificate using the dispenser leaf certificate. The dispenser certificate may include, as an issuer, an HFO subsequent certificate authority of a vehicle-to-device (V2D) root certificate authority. An issuer signature of the dispenser certificate may be verified using a public key of the second subsequent certificate authority.

The hydrogen fueling communication method may further comprise encrypting a message using a private key of the dispenser and a public key of a receiver being a hydrogen fueled mobility or a user of the hydrogen fueled mobility, encrypting the private key of the dispenser using the public key of the receiver, and transmitting the encrypted message and the encrypted private key to the receiver.

The hydrogen fueling communication method may further comprise mutually authenticating the hydrogen fueled mobility and the dispenser using a certificate of the hydrogen fueled mobility in the performing of the handshake.

The certificate of the hydrogen fueled mobility may comprise an OEM (original equipment manufacturer) provisioning certificate. The OEM provisioning certificate may be issued by an OEM subordinate certification authority that has received an OEM subordinate certificate, such that the OEM provisioning certificate includes a signature value generated by signing a public key and identification information of the hydrogen fueled mobility using a private key of the OEM subordinate certification authority and the signed information. The OEM subordinate certificate may be issued by an OEM root certification authority such that the OEM subordinate certificate includes a signature value generated by signing a public key and identification information of the OEM subordinate certification authority using a private key of the OEM root certification authority and the signed information.

A public key of the OEM provisioning certificate may be used by the hydrogen fueled mobility to verify an issuer signature of the second subsequent certificate authority.

The hydrogen fueling communication method may further comprise verifying validity of a counterpart certificate by at least one entity of the hydrogen infrastructure including the dispenser and the hydrogen fueled mobility, using an online certificate status protocol (OCSP) or a certificate revocation list (CRL).

The hydrogen fueling communication method may perform data communication using transport layer security (TLS).

The hydrogen fueling communication method may further comprise transmitting a contract authorization message having an encrypted digital signature to the dispenser.

The hydrogen fueling communication method may further comprise encrypting a message used for communication with a mobility operator.

The hydrogen fueling communication method may further comprise receiving a sales tariff including an encrypted digital signature from the mobility operator.

The hydrogen fueling communication method may further comprise transmitting a metering receipt request message including an encrypted digital signature to the mobility operator.

A hydrogen fueling communication method by a hydrogen fueled mobility according to other exemplary embodiment, comprises requesting installation of certificate in a hydrogen fueling operator (HFO) or a dispenser belonging to the HFO in a hydrogen infrastructure; and receiving an OEM provisioning certificate issued by an original equipment manufacturer (OEM) belonging to the hydrogen infrastructure. The receiving of the OEM provisioning certificate, comprises: generating, by an OEM root certificate authority, an OEM first subordinate certificate including a signature value and signed information by signing a public key and identification information of a first OEM subsequent certificate authority using the OEM root certificate authority's private key; generating, by the first OEM subsequent certificate authority, an OEM second subordinate certificate including a signature value and signed information by signing a public key and identification information of a second OEM subsequent certificate authority using the first OEM subsequent certificate authority's private key; and issuing, by the second OEM subsequent certificate authority, the OEM provisioning certificate including a signature value and signed information by signing a public key and identification information of the hydrogen fueled mobility using the second OEM subsequent certificate authority's private key.

The hydrogen fueling communication method may further comprise performing a transport layer security (TLS) handshake with at least one entity of the hydrogen infrastructure including the dispenser.

The dispenser may possess a dispenser certificate. The dispenser certificate may be generated using the dispenser leaf certificate and a private key of the dispenser. The dispenser certificate may include, as an issuer, an HFO subsequent certificate authority of a vehicle-to-device (V2D) root certificate authority. An issuer signature of the dispenser certificate may be verified using a public key of the second OEM subsequent certificate authority.

An apparatus using a hydrogen fueling communication method according to an exemplary embodiment, comprises a processor and at least one instruction loaded on the processor. The at least one instruction causes the processor to perform: receiving, from an upper root server, a first subordinate certificate that includes a signature value and signed information, the signature value generated by signing a public key and identification information of a first subsequent certificate authority of the HFO using a private key of the upper root server; generating, by the first subsequent certificate authority, a second subordinate certificate that includes a signature value and signed information, the signature value generated by signing a public key and identification information of a second subsequent certificate authority using the private key of the first subsequent certificate authority; and issuing, by the second subsequent certificate authority, a dispenser leaf certificate that includes a signature value and signed information, the signature value generated by signing a public key and identification information of a dispenser using the private key of the second subsequent certificate authority.

The processor may further perform a handshake of transport layer security (TLS) with at least one entity of the hydrogen infrastructure to which the HFO belongs. The handshake may include mutual authentication between the dispenser and the hydrogen fueled mobility using a certificate of the hydrogen fueled mobility.

The processor may further perform generating a dispenser certificate using the dispenser leaf certificate and a private key of the dispenser. The dispenser certificate may include, as an issuer, an HFO subsequent certificate authority of a vehicle-to-device (V2D) root certificate authority, and an issuer signature of the dispenser certificate may be verified using a public key of the second subsequent certificate authority.

The processor may further performs encrypting a message using a private key of the dispenser and a public key of a receiver being a hydrogen fueled mobility, encrypting the private key of the dispenser using the public key of the receiver

The processor may further performs transmitting the encrypted private key together with the encrypted message to the hydrogen fueled mobility; or verifying validity of a counterpart certificate using an online certificate status protocol (OCSP) or a certificate revocation list (CRL).

The processor may transmit or receive messages related to hydrogen fueling through data communication using transport layer security (TLS).

The processor may further perform a step of transmitting a contract authorization message having an encrypted digital signature to the dispenser.

The processor may further perform a step of encrypting messages used for communication with a mobility operator.

The processor may further perform a step of receiving a sales tariff including an encrypted digital signature from the mobility operator.

The processor may further perform a step of transmitting a metering receipt request message including an encrypted digital signature to the mobility operator.

The processor may further perform a step of transmitting a certificate installation request message including an encrypted digital signature to a certificate provisioning service provider.

The processor may further perform a step of receiving a certificate installation response message including an encrypted digital signature from the certificate provisioning service provider.

The processor may further perform a step of using a hash-based message authentication code (HMAC) and a signature for message digest or message compression.

### Advantageous Effects

According to the present disclosure, a new hydrogen fuel supply communication method may be provided, in which public key infrastructure (PKI)-based security is applied to hydrogen fueling communication between a hydrogen infrastructure and hydrogen-fueled mobility.

In addition, according to the present disclosure, in the hydrogen fuel supply communication between the hydrogen infrastructure and the hydrogen-fueled mobility, PKI-based security may be applied to enable unfamiliar entities to effectively verify their identities in the hydrogen fuel supply communication.

Furthermore, according to the present disclosure, by applying PKI-based security to the hydrogen fuel supply communication, trust relationships among entities may be effectively extended even to unfamiliar entities by using cross-certificates in the hydrogen fuel supply communication.

### DESCRIPTION OF DRAWINGS

FIG. 1 is a schematic diagram illustrating a hardware configuration of a hydrogen infrastructure to which a hydrogen fuel supply communication method according to exemplary embodiments of the present disclosure may be applied.

FIG. 2 is a conceptual diagram illustrating a hydrogen fuel supply control process to which a hydrogen fuel supply communication method according to exemplary embodiments of the present disclosure may be applied.

FIG. 3 is a conceptual diagram for explaining state transitions occurring during a hydrogen fuel supply process for hydrogen-fueled mobility, in which a hydrogen fuel supply communication method according to exemplary embodiments of the present disclosure may be employed.

FIGS. 4A and 4B are exemplary diagrams for explaining key principles of public key cryptography (PKC), which may be employed in the hydrogen fuel supply communication method of the present embodiment.

FIGS. 5A and 5B are exemplary diagrams for explaining key principles of public key infrastructure (PKI), which may be employed in the hydrogen fuel supply communication method of the present embodiment.

FIG. 6 is an exemplary diagram illustrating a PKI structure that may be employed in the hydrogen fuel supply communication method according to exemplary embodiments of the present disclosure.

FIG. 7 is an exemplary diagram of a hydrogen fuel supply ecosystem to which a hydrogen fuel supply communication method according to exemplary embodiments of the present disclosure may be applied.

FIG. 8 is an exemplary diagram of a hydrogen fuel supply ecosystem for explaining a hydrogen fuel supply communication method according to another exemplary embodiments of the present disclosure.

FIG. 9 is an exemplary diagram for explaining a hydrogen fuel supply procedure with cross-signing, in order to explain a hydrogen fuel supply communication method according to still another exemplary embodiments of the present disclosure

FIG. 10 is a schematic block diagram of an apparatus using a hydrogen fuel supply communication method according to still another exemplary embodiments of the present disclosure.

### BEST MODE OF THE INVENTION

For a clearer understanding of the features and advantages of the present disclosure, exemplary embodiments of the present disclosure will be described in detail with reference to the accompanying drawings.

However, it should be understood that the present disclosure is not limited to particular embodiments disclosed herein but includes all modifications, equivalents, and alternatives falling within the spirit and scope of the present disclosure. In the drawings, similar or corresponding components may be designated by the same or similar reference numerals.

The terminologies including ordinals such as “first” and “second” designated for explaining various components in this specification are used to discriminate a component from the other ones but are not intended to be limiting to a specific component. For example, a second component may be referred to as a first component and, similarly, a first component may also be referred to as a second component without departing from the scope of the present disclosure. As used herein, the term “and/or” may include a presence of one or more of the associated listed items and any and all combinations of the listed items.

In the description of exemplary embodiments of the present disclosure, “at least one of A or B” may mean “at least one of A and B” or “at least one of combinations of one or more of A and B”. In addition, in the description of exemplary embodiments of the present disclosure, “one or more of A and B” may mean “one or more of A or B” or “one or more of combinations of one or more of A and B”.

When a component is referred to as being “connected” or “coupled” to another component, the component may be directly connected or coupled logically or physically to the other component or indirectly through an object therebetween. Contrarily, when a component is referred to as being “directly connected” or “directly coupled” to another component, it is to be understood that there is no intervening object between the components. Other words used to describe the relationship between elements should be interpreted in a similar fashion.

The terminologies are used herein for the purpose of describing particular exemplary embodiments only and are not intended to limit the present disclosure. The singular forms include plural referents as well unless the context clearly dictates otherwise. Also, the expressions “comprises,” “includes,” “constructed,” “configured” are used to refer a presence of a combination of stated features, numbers, processing steps, operations, elements, or components, but are not intended to preclude a presence or addition of another feature, number, processing step, operation, element, or component.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with their meanings in the context of related literatures and will not be interpreted as having ideal or excessively formal meanings unless explicitly defined in the present application.

Terms used in the present disclosure are defined as follows.

“Hydrogen-fueled vehicle”, in a broad sense, may include not only a hydrogen fuel cell vehicle or a fuel cell electric vehicle (FCEV) that uses a fuel cell, but also a vehicle based on an internal combustion engine (ICE) that directly uses hydrogen as fuel. This vehicle may be referred to as a hydrogen-fueled vehicle.

“Hydrogen-fueled mobility” refers to mobility that uses hydrogen as an energy source or generates electric energy using hydrogen as fuel and drives a motor using the electric energy. Hydrogen-fueled mobility may include, in addition to hydrogen-fueled vehicles, industrial trucks, trains, ships, aircraft, aerial mobility, or devices that generate electric energy using hydrogen as fuel and drive a motor using the generated electric energy. Furthermore, hydrogen-fueled mobility may include automobiles, automobiles in the general sense, or hybrid means of transportation that use both human power and hydrogen fuel.

In the following exemplary embodiments, a fueling protocol and/or a communication protocol for hydrogen fueling may be applied to the hydrogen-fueled mobility.

“CHSS” (compressed hydrogen storage system) refers to a device that stores hydrogen fuel fluid, i.e., hydrogen fuel or compressed hydrogen, as part of the vehicle/mobility. The hydrogen fuel may include gaseous hydrogen fuel or liquid hydrogen fuel. That is, the hydrogen fuel may include at least one of hydrogen in a gas state and hydrogen in a liquid state, and it may basically refer to compressed hydrogen, but is not limited thereto.

“Pressure relief device” (PRD) is disposed in the CHSS and refers to a device that can isolate stored hydrogen from the rest of the fuel system and the environment, or conversely, discharge the hydrogen to the outside.

“Pressure Ramp Rate (PRR)” refers to an increase rate of a pressure of CHSS and measured in mega-pascals per minute (MPa/min). “Average Pressure Ramp Rate (APRR)” refers to an average of the increase rate of the pressure from the beginning to the end of the hydrogen fueling.

“Pre-cooling” refers to the process of cooling hydrogen gas in advance at a hydrogen station before charging it into an electric vehicle or the like. “Dispenser” refers to a component that delivers the pre-cooled hydrogen to the CHSS. The dispenser is placed in a hydrogen station and may perform hydrogen fueling between the hydrogen storage tank of the hydrogen station and the CHSS of the vehicle. “Nozzle” refers to a device that is connected to the dispenser, coupled to the receptacle of a hydrogen electric vehicle, and allows the delivery of hydrogen fuel.

The above-described hydrogen charging basically refers to a process of compressively storing high-pressure hydrogen supplied from a dispenser of a gas station or a hydrogen station into the fuel tank of a vehicle. Hydrogen charging may be used interchangeably with fueling in the sense of supplying hydrogen fuel to a hydrogen fuel cell vehicle. That is, in the present specification, “fueling” may be used in the sense of fuel supply, hydrogen charging, or charging, and charging may mean charging of hydrogen fuel. For example, a fueling protocol may be referred to as a charging protocol, a fueling session may be referred to as a charging session, and a fueling method may be referred to as a hydrogen charging method or a charging (fueling) method.

“Fueling session” may be used to refer to communication sessions performed for each use case for hydrogen fueling.

“Interoperability” may refer to a state in which components of relatively different systems can operate together to perform the intended operation of the entire system. Information interoperability may refer to the ability of two or more networks, systems, devices, nodes, actors, entities, applications, or components to safely and effectively share and use information with little or no inconvenience to the user.

“Correlation” or “association” may include a procedure for establishing a relationship between two peer communication entities.

“Command and control communication” may refer to communication between a hydrogen fueling device and a hydrogen fuel cell vehicle for exchanging information necessary for the initiation, control, and termination of the hydrogen fueling process.

The following are key terms related to transport layer security (TLS) used in the present exemplary embodiment.

“Client” is an endpoint that initiates a TLS connection. “Connection” is a transport-layer connection between two endpoints. “Endpoint” is either the client or the server in the connection. “Handshake” is the initial negotiation between the client and the server to establish parameters for subsequent interactions in TLS.

“Peer” is an endpoint. When referring to a specific endpoint, “peer” refers to the endpoint that is not the main subject of discussion. “Receiver” is the endpoint that receives a record. “Sender” is the endpoint that transmits a record. “Server” is the endpoint that did not initiate the TLS connection.

In the following detailed description, exemplary embodiments related to hydrogen fuel cell vehicles may be illustrated for convenience of explanation. However, it will be apparent to those skilled in the art that the spirit of the present disclosure can be applied to various types of hydrogen-fueled mobility. In addition, the bidirectional communication process for hydrogen fueling according to the present disclosure may be partially applied not only to hydrogen-fueled mobility but also to buildings or facilities that use hydrogen as an energy source.

Also, although a hydrogen fuel cell vehicle is mainly described for convenience of explanation as the vehicle using the bidirectional process in hydrogen fueling communication, the scope is not limited thereto, and may include electric vehicles (EVs) in hybrid forms using hydrogen as fuel, internal combustion engine (ICE) vehicles, and the like.

In the present specification, part or all of the process of a communication method performed in hydrogen-fueled mobility, a communication protocol negotiation method, a hydrogen fueling protocol negotiation method, a hydrogen fueling parameter negotiation method, and a hydrogen fueling control method may be performed by an electronic control unit (ECU), communication device, or communication controller within the hydrogen-fueled mobility.

In the present specification, part or all of the process of a communication method, communication protocol negotiation method, hydrogen charging protocol negotiation method, hydrogen charging parameter negotiation method, and hydrogen charging control method performed at the dispenser may be carried out by a controller, electronic control unit, communication device, or communication controller of the dispenser. In addition, part of the above methods may be performed by a controller, electronic control unit, communication device, or communication controller of a hydrogen station associated with the dispenser.

Meanwhile, even technologies that were publicly known before the filing date of the present application may be included as part of the configuration of the present invention when necessary, and such inclusion may be described in the present specification within a scope that does not obscure the spirit of the present disclosure. That is, the spirit of the present disclosure is not to claim rights over known technologies mentioned herein, but rather that known technologies may be included as part of the present disclosure within a scope that does not depart from the spirit of the present invention. However, in describing the configuration of the present application, detailed descriptions of known technologies that can be readily understood by those skilled in the art prior to the filing date are omitted, since such details may obscure the spirit of the present disclosure.

For example, a technology using a thermodynamic model for hydrogen charging control, a technology applying a model predictive control (MPC) technique for generalized dynamic control, or a technology for configuring and controlling an artificial neural network for training and inference of neural networks may utilize known technologies prior to the filing of the present disclosure. At least some of these known technologies may be applied as essential technologies for implementing the present invention.

Hereinafter, exemplary embodiments of the present disclosure will be described referring to following figures.

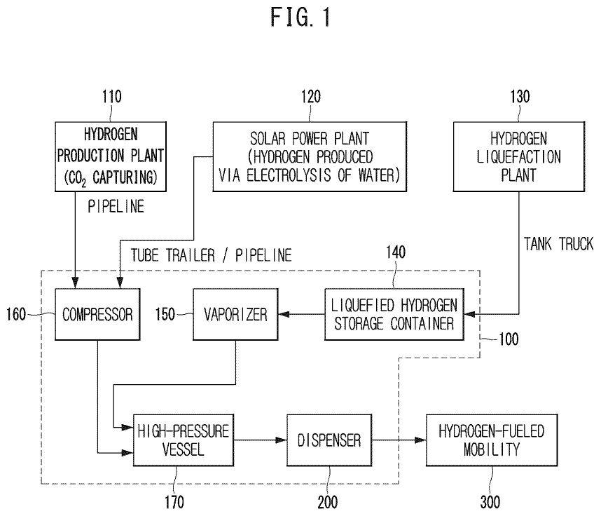

FIG. 1 is a schematic diagram illustrating a hardware configuration of a hydrogen infrastructure to which a hydrogen fuel supply communication method according to exemplary embodiments of the present disclosure may be applied.

As shown in FIG. 1, the hydrogen infrastructure may include a blue fueling station infrastructure, a green fueling station infrastructure, and a liquid fueling station infrastructure, depending on the hydrogen fuel production method or fluid state. The blue fueling station infrastructure may include a blue fueling station, which is a type of hydrogen fueling station. The green fueling station infrastructure may include a green fueling station, which is a type of hydrogen fueling station. The liquid fueling station infrastructure may include a liquid fueling station, which is also a type of hydrogen fueling station.

In the exemplary embodiments, for the sake of convenience in illustration, a hydrogen fueling station 100 having the integrated functions of a blue fueling station, a green fueling station, and a liquid fueling station is exemplified. However, the present disclosure is not limited to the configuration of such a hydrogen fueling station 100. For example, a compressor 160, a high-pressure vessel 170, and a dispenser 200, which will be described later, may be independently arranged in each of the blue fueling station, the green fueling station, and the liquid fueling station. However, a liquefied hydrogen storage container 140 and a vaporizer 150 may be arranged only in the liquid fueling station. The hydrogen fueling station 100 may be a term that simply refers to a hydrogen fueling station operator or a hydrogen fuel supply operator.

In the blue fueling station infrastructure, the blue fueling station may receive hydrogen gas produced by a hydrogen production plant 110. The gas produced by the hydrogen production plant 110 may be supplied to the compressor 160 of the blue fueling station through a pipeline after carbon dioxide (CO₂) included in the gas is captured. The hydrogen gas compressed by the compressor 160 may be stored in the high-pressure vessel 170.

In the green fueling station infrastructure, the green fueling station may receive electrolysis hydrogen obtained through water electrolysis using electricity generated by a solar power plant 120. The hydrogen gas produced by the solar power plant 120 may be supplied to the compressor 160 of the green fueling station through a pipeline or tube trailer, or the like. The hydrogen gas compressed by the compressor 160 may be stored in the high-pressure vessel 170.

In the liquid fueling station infrastructure, the liquid fueling station may receive liquefied hydrogen produced by a hydrogen liquefaction plant 130. The liquefied hydrogen produced by the hydrogen liquefaction plant 130 may be stored in the liquid storage container of the liquid fueling station via a tanker truck and may be stored in the high-pressure vessel 170 through the vaporizer.

The compressed hydrogen stored in the high-pressure vessel 170 may be supplied to a hydrogen storage system of the hydrogen-fueled mobility 300. That is, the compressed hydrogen stored in the high-pressure vessel 170 may be injected into a high-pressure hydrogen tank of the hydrogen storage system under the control of a control device of the hydrogen fueling station or a control device of the dispenser 200, through a nozzle of the dispenser 200 that is connected to a receptacle of the hydrogen-fueled mobility 300.

The hydrogen-fueled mobility 300 refers to mobility that directly or indirectly uses hydrogen to generate driving force, and may also be referred to as a hydrogen powered fuel cell utility vehicle, a concept similar to a hydrogen fuel cell vehicle.

In the above-described configuration, hydrogen fuel supply data may be transmitted from the hydrogen-fueled mobility 300 to the hydrogen fueling station 100 through the dispenser 200 via a communication network formed among the hydrogen fueling station 100, the dispenser 200, and the hydrogen-fueled mobility 300. For example, for hydrogen fuel supply communication, the dispenser 200 may couple a first control device or a first communication device of the hydrogen fueling station 100 with a second control device or a second communication device of the hydrogen-fueled mobility 300.

That is, the dispenser 200 may function as a fueling interface for hydrogen fuel supply communication between the hydrogen fueling station 100 and the hydrogen-fueled mobility 300. Additionally, the dispenser may be referred to as a fueling interface for hydrogen fuel supply communication between the hydrogen infrastructure including the hydrogen fueling station 100 and the hydrogen-fueled mobility 300.

In particular, the security method in the hydrogen fuel supply communication of the present embodiments may be configured to perform key exchange, authenticated encryption, the like for confidentiality, to perform authenticated encryption for integrity, to perform digital signatures for authentication and non-repudiation, or to use hashing for message digest, based on public key infrastructure.

In the present disclosure, the hydrogen infrastructure may be referred to as a hydrogen fueling infrastructure or simply as a hydrogen infrastructure. In addition, the hydrogen fueling station may be referred to as a hydrogen fueling station or a hydrogen forecourt station, and may also be simply referred to as a hydrogen station.

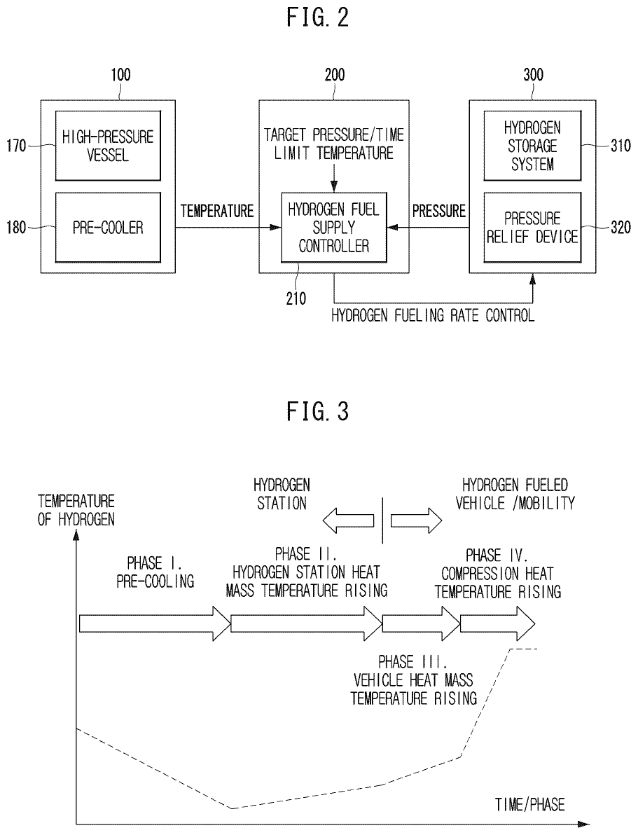

FIG. 2 is a conceptual diagram illustrating a hydrogen fuel supply control process to which a hydrogen fuel supply communication method according to exemplary embodiments of the present disclosure may be applied.

As shown in FIG. 2, the hydrogen fuel supply control process includes supplying pre-cooled hydrogen gas from a hydrogen fueling station 100 to a hydrogen-fueled mobility 300 via a dispenser 200. The hydrogen fuel supply control may be performed through parameter control including a pressure rise rate (PRR) or an average pressure rise rate (APRR), in order to control the hydrogen fuel supply rate.

The hydrogen fueling station 100 may include a high-pressure vessel 170 and a pre-cooler 180. The dispenser 200 may include a hydrogen fuel supply controller 210. The hydrogen-fueled mobility 300 may include a hydrogen storage system 310 and a pressure relief device 320, or the like.

While the hydrogen fuel supply is in progress, to respond to the phenomenon of rising hydrogen gas temperature, the hydrogen fueling station 100 may include the high-pressure vessel 170 for storing high-pressure hydrogen and the pre-cooler 180. The hydrogen fueling station 100 may supply hydrogen gas in a pre-cooled state, in which the gas temperature is lowered by the pre-cooler 180, to the hydrogen-fueled mobility 300 via the dispenser 200.

The interface between the hydrogen fueling station 100 and the hydrogen-fueled mobility 300 is handled by the dispenser 200, and the dispenser 200 controls a target pressure, target time, limit temperature, fueling rate, or the like in the hydrogen fuel supply, by integrating hydrogen fuel supply-related information (first information) such as the ambient temperature and the delivered gas temperature of the hydrogen fueling station 100, and high-pressure hydrogen tank-related information (second information) such as the initial gas pressure of the hydrogen-fueled mobility 300. As the control logic, control logic complying with the SAE J2601 standard may be used. The fueling rate, i.e., hydrogen fuel supply rate, may be controlled based on the average pressure rise rate.

The hydrogen storage system 310 mounted on the hydrogen-fueled mobility 300 may be a compressed hydrogen storage system (CHSS), and may include a high-pressure hydrogen tank, a pressure control mechanism, high-pressure piping, and an outer frame. The high-pressure hydrogen tank may have a capacity of several tens to several hundreds of liters. In the case of vehicles, high-pressure hydrogen tanks may be used by connecting small and lightweight storage tanks in parallel to ensure high capacity. In this specification, for convenience of description, the expressions “high-pressure hydrogen tank” and “CHSS” may be used interchangeably.

In addition, the hydrogen storage system 310 may control hydrogen storage using a boss unit capable of regulating inflow and outflow of hydrogen gas to and from the high-pressure hydrogen tank. Due to the characteristic that hydrogen injection and utilization may not be performed simultaneously, a single boss unit may be equipped with a valve, a pressure reduction mechanism, and various sensors for measurement in order to control hydrogen storage.

In the method for delivering information from the hydrogen-fueled mobility 300 to the dispenser 200, communication method or a non-communication method may be used. In the case of using the communication method, the temperature and/or pressure value of the high-pressure hydrogen tank 310 may be transmitted to the dispenser 200 in a unidirectional manner only, and the dispenser 200 may use such information not proactively, but only for safety criteria such as emergency stop at a limit temperature or pressure.

The logic for safe and rapid hydrogen fuel supply may be managed by the dispenser 200 or the hydrogen-fueled mobility 300. The hydrogen-fueled mobility 300 may be equipped only with a minimal safety management device that automatically releases hydrogen gas stored in the high-pressure hydrogen tank 310 under overheating or other conditions, through a pressure relief device (PRD) 320 coupled to the high-pressure hydrogen tank 310, without an active safety management method.

For example, the hydrogen fuel supply controller 210 inside the dispenser 200 may control the hydrogen fueling process by actively utilizing status information such as temperature and pressure received from the hydrogen-fueled mobility 300 and the hydrogen fueling station 100, and charging status information such as the state of charge (SOC) of the compressed hydrogen tank 310.

The hydrogen fuel supply controller 210 may be configured to control the hydrogen fuel supply rate in real time based on real-time temperature data of the high-pressure hydrogen tank 310, so as to operate at the maximum fueling rate that satisfies safety thresholds. Accordingly, the hydrogen fueling time may be shortened within the available range. Such a hydrogen fuel supply controller 210 may be implemented based on an artificial neural network (ANN).

Meanwhile, in the conventional hydrogen fuel supply protocol, safety limit conditions are excessively set, resulting in problems such as the temperature of most compressed hydrogen tanks 310 being measured around 40 to 50° C. at the end of fueling, due to excessive pre-cooling of hydrogen gas before the hydrogen gas is supplied to the hydrogen-fueled mobility 300. In the present embodiment, by actively adjusting the required and supplied amount of pre-cooling, the cooling load of the hydrogen fueling station 100 may be optimized, thereby improving the operational efficiency of the hydrogen fueling station 100.

Furthermore, the conventional protocol, which is set based on lightweight hydrogen electric vehicles, has a drawback in that all variables must be reset and reflected in the standard when fueling new mobility. Meanwhile, according to the present embodiments, by applying an ANN-based hydrogen fuel supply control logic that updates the logic itself through a certain learning and training process, the hydrogen fuel supply procedure may be effectively performed and controlled even for unfamiliar hydrogen-fueled mobility, i.e., new hydrogen-fueled mobility that is connected to the dispenser 200 for the first time.

As described above, the hydrogen fuel supply process of the present embodiments may be configured such that the dispenser 200 is responsible for the control between the hydrogen-fueled mobility 300 and the hydrogen fueling station 100. The dispenser 200 may be equipped with a hydrogen fueling protocol, which is a method for injecting hydrogen into the hydrogen-fueled mobility 300, and may comprehensively manage the hydrogen fuel supply control according to the rules defined in the protocol.

In addition, the hydrogen fuel supply process may perform simulations through thermodynamic modeling for various situations regarding the minimum requirements for safety, and may perform partial real-time correction based on an MC formula protocol. Of course, depending on the implementation, a table-based protocol may be applied in which a lookup table is configured using parameters derived through simulation, and the fueling output is controlled using the configured lookup table.

The above-described minimum requirements for safety may follow upper limits for the temperature and pressure conditions of the CHSS of the hydrogen storage system 310 and guidelines for the state of charge (SOC). The simulation may be performed through thermodynamic modeling using boundary conditions that include both a best case and a worst case.

The above-described configuration may also be applied to the configuration of the exemplary embodiments of the present disclosure within the scope corresponding to the object of the present disclosure.

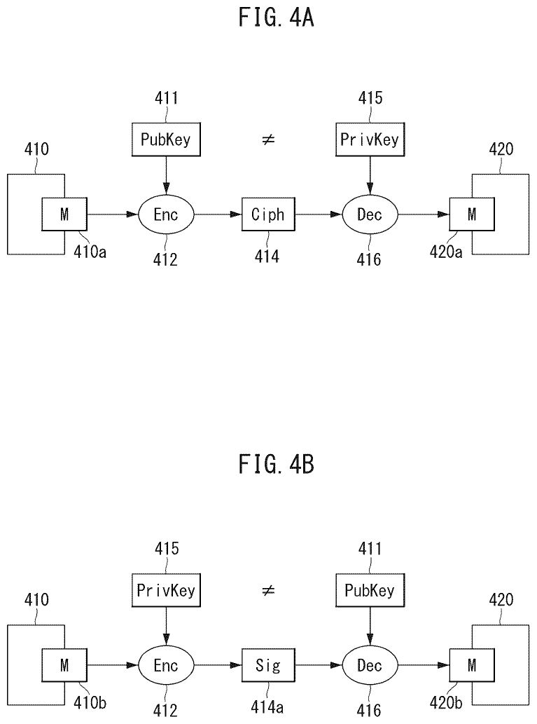

FIG. 3 is a conceptual diagram for explaining state transitions occurring during a hydrogen fuel supply process for hydrogen-fueled mobility, in which a security method in hydrogen fuel supply communication according to exemplary embodiments of the present disclosure may be employed.

As shown in FIG. 3, when hydrogen is injected into a high-pressure hydrogen tank, the internal temperature rises due to compression heat, thereby increasing the temperature of the hydrogen gas inside the high-pressure hydrogen tank. Temperature control in the hydrogen fuel supply process is achieved by supplying pre-cooled hydrogen gas such that, at the final point of completion of charging, the internal temperature of the high-pressure hydrogen tank is controlled to be 85° C. or lower.

In order to block heat exchange between the external atmosphere and the hydrogen gas stored inside the tank during driving, the high-pressure hydrogen tank includes carbon fiber that has low thermal conductivity, and covers the dome and body of the tank. Therefore, when the temperature of the hydrogen gas inside the high-pressure hydrogen tank rises during the fueling process, the temperature rise observable on the surface of the high-pressure hydrogen tank is relatively small compared to the internal temperature rise, due to the low thermal conductivity characteristics of the tank. This characteristic results in minimal heat exchange with the ambient air, as the external air is blocked during hydrogen fuel supply, thereby requiring a separate temperature management plan to mitigate the rapid temperature rise inside the high-pressure hydrogen tank.

In conventional technologies, no separate cooling means are included other than receiving pre-cooled hydrogen gas from the hydrogen fueling station. That is, in the conventional art, the hydrogen fueling station simply manages the upper temperature limit of the high-pressure hydrogen tank mounted in the hydrogen-fueled mobility—set at 85° C. or below—by controlling pre-cooling and hydrogen injection speed. No separate temperature management plan is provided for the high-pressure hydrogen tank in the hydrogen-fueled mobility. As a result, particularly in summer when the ambient temperature is high, it becomes difficult for the hydrogen fueling station to control the temperature of the high-pressure hydrogen tank, leading to problems such as fueling delays.

In the present embodiment, a characteristic curve of hydrogen temperature according to the hydrogen fuel supply time/phase, as shown in FIG. 3, is loaded as a basic model. Then, real-time data reflecting environmental variables such as ambient temperature, atmospheric pressure, and weather conditions are considered to divide the hydrogen fuel supply process into a first phase (phase I), a second phase (phase II), a third phase (phase III), and a fourth phase (phase IV), and to optimize the control of the fueling rate or pressure rise rate (PRR) in each phase. This allows for derivation of optimal control conditions suitable for actual environmental conditions. Here, the first phase represents a pre-cooling process at the hydrogen fueling station, the second phase represents a thermal mass temperature rise process at the hydrogen fueling station, the third phase represents a thermal mass temperature rise process in the vehicle, and the fourth phase represents a compression heat temperature rise process in the vehicle.

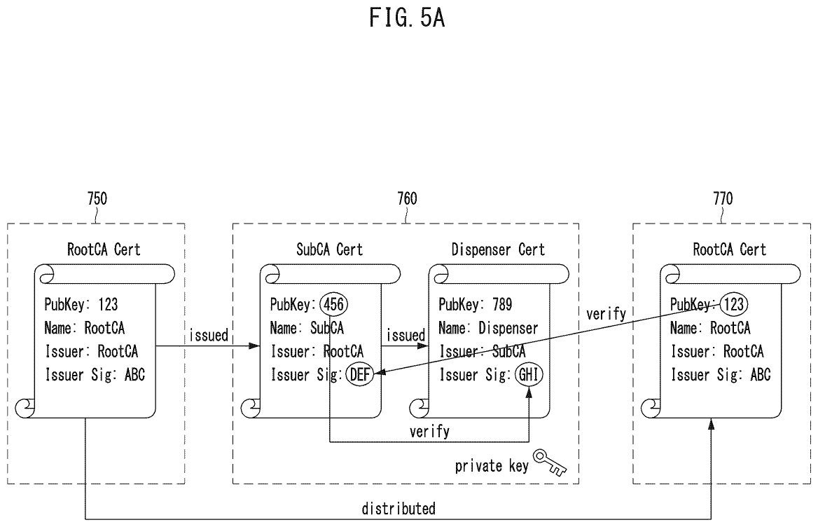

FIGS. 4A and 4B are exemplary diagrams for explaining key principles of public key cryptography (PKC), which may be applied to the hydrogen fuel supply communication method of the present embodiment.

Public key cryptography refers to an encryption method in which different keys are used for encryption and decryption, unlike secret key encryption that uses the same key for both processes. Public key cryptography is also referred to as asymmetric key encryption, in contrast to symmetric key encryption where the same key is used for both encryption and decryption.

For example, as shown in FIG. 4A, in the encryption mode of public key cryptography, a first entity 410 including a sender may encrypt plain text 410a using a public key (PubKey) 411 to generate cipher text (Ciph) 414 through an encryption (Enc) process 412. A second entity 420 including a receiver may receive the cipher text 414 and decrypt the cipher text 414 using a private key (PrivKey) 415 through a decryption (Dec) process 416 to obtain plain text 420a. Here, the public key is the sender's public key known to the public, and the private key is the sender's private key. The private key may also be referred to as a personal key or secret key. This public key cryptography may be used primarily for encrypting small messages, particularly for key exchange purposes.

Also, for example, as shown in FIG. 4B, in the authentication mode of public key cryptography, a first entity 410 including a sender may encrypt a message 410b with a private key 415 to generate a message including a signature (Sig) 414a through an encryption (Enc) process 412. A second entity 420 including a receiver may receive the message including the signature 414a and decrypt the message including the signature 414a using the public key 411 through a decryption (Dec) process 416 to verify the message 420b. This type of public key cryptography may be used to authenticate messages in order to prevent repudiation of signatures.

As described above, when using public key cryptography (PKC), each entity may generate and possess a key pair consisting of a public key and a private key. Here, the public key may be distributed or known to public users, and the private key may be a secret key used only by its owner without being exposed externally.

Using public key cryptography, data, certificates, or the like may be encrypted with the public key and decrypted with the private key. Additionally, documents such as certificates may be signed with the private key and verified with the public key. That is, by using public key cryptography, only a user having a specific private key may read the content of the plaintext in a message, and anyone may verify that the message was created using that specific private key.

Public key cryptography may, for example, be used in the process of electric vehicle charging or hydrogen fuel supply for electric vehicles, enabling hydrogen-fueled mobility to verify the certificate chain of the dispenser and authenticate the dispenser as the owner of the corresponding certificate. Such public key cryptography may be used in conjunction with digital signatures in a public key infrastructure (PKI) within a hydrogen infrastructure.

This public key infrastructure (PKI) is currently the only practical method for providing a scalable trust ecosystem to an arbitrary number of entities that may encounter governance structures in a random manner. The core technology of PKI is the aforementioned public key cryptography (PKC).

The PKI described above may be used so that user of hydrogen-fueled mobility or hydrogen-fueled mobility receives a certificate including a public key and a private key from a certificate authority (CA) to enable secure communication over a network. The public key may be issued by the CA. This PKI may be applied to any domain where digital certificates are used, such as web security, mobile security, Wi-Fi security, inter-organizational communications, financial identity verification, government agencies, electric vehicle (EV) charging, autonomous driving, intelligent transport systems (ITS), and so on.

Furthermore, the PKI may use at least one public key cryptography (PKC) method selected from among Diffie-Hellman key exchange, RSA (Ron Rivest, Adi Shamir, Leonard Adleman) encryption, DSA (Digital Signature Algorithm), elliptic curve cryptography (ECC), or the like. In other words, the PKI may use transport layer security such as secure sockets layer (SSL), TLS 1.2, TLS 1.3, datagram TLS (DTLS), or the like. The PKI may use digital signature algorithms such as the digital signature algorithm (DSA), elliptic curve DSA (ECDSA), and encryption hash functions. The PKI may also use digital certificates such as X.509, certificate chains, and cross-certificates. Moreover, the PKI may utilize certification authorities such as a root certificate authority (rootCA), subordinate CA (Sub-CA), VeriSign, Amazon, Microsoft (MS), Google, or the like.

As such, the PKI used in the hydrogen fuel supply communication method of the present embodiments may be used to establish trust among entities or actors in the hydrogen infrastructure. The actors may include hydrogen-fueled mobility, users of the hydrogen-fueled mobility, hydrogen fuel supply devices, hydrogen fueling operators (HFO), mobility service providers (MSP), original equipment manufacturers (OEMs), and the like. The hydrogen fuel supply device may include a dispenser, and the hydrogen fueling operator may be included as at least a part of a charging station operator (CSO). Such a PKI may be configured to support functions such as registration or renewal of actors, authentication of actors, and revocation or deregistration of actor certificates.

Using the above-described PKI, trust among unfamiliar entities may be authenticated through a trust anchor. That is, unfamiliar entities may verify their identities and establish secure channels for privacy protection and integrity. In addition, PKI may be used to extend trust relationships by utilizing cross-certificates.

Furthermore, using PKI, assuming that no user falsely presents their public key, security may be ensured by knowing the public key of the other party. For example, a certificate may prove what the public key of a dispenser is, which is signed by a subordinate CA. In this case, the public key of the subordinate CA may be authenticated by another certificate of another CA. The public key of that other CA may, in turn, be authenticated by yet another certificate of yet another CA. This creates a need for an infinite number of CAs. Therefore, in the present embodiments, it is assumed that the verifier knows the public key of a CA that is definitively trusted. This CA may be referred to as a root CA or a trust anchor. In other words, using such a root CA or trust anchor, the dispenser certificate chain may be effectively verified for each hydrogen-fueled mobility.

Meanwhile, transport layer security (TLS) is a network protocol that has been used for decades. Using TLS, peers may be authenticated mutually or unilaterally, secret keys may be exchanged over insecure channels, and secure channels with confidentiality and integrity may be established. As such, TLS may be widely used in various implementations. That is, TLS may be used in almost every application of hydrogen fuel supply communication and may overlap in part with where PKI is used.

This TLS may be used when hydrogen-fueled mobility and a dispenser establish a transmission control protocol (TCP) connection, by performing a TLS handshake after the TCP handshake.

By using TLS, the hydrogen-fueled mobility may trust the dispenser based on certificate chain of the dispenser. Also, the dispenser may trust the hydrogen-fueled mobility based on the certificate chain of the hydrogen-fueled mobility. In this way, TLS enables encrypted communication and integrity-protected communication between the hydrogen-fueled mobility and the dispenser to be effectively performed.

Meanwhile, during the use of TLS, when the hydrogen-fueled mobility provides certificate chain of the hydrogen-fueled mobility to the dispenser, the dispenser may verify the identity of the hydrogen-fueled mobility using the public key. Likewise, when the dispenser provides certificate of dispenser to the hydrogen-fueled mobility, the hydrogen-fueled mobility may verify the identity of the dispenser using the public key. The hydrogen-fueled mobility and the dispenser may exchange keys using the Diffie-Hellman algorithm. That is, the hydrogen-fueled mobility and the dispenser may secretly generate encryption keys for integrity. As such, the hydrogen-fueled mobility and the dispenser may perform secure communication using TLS.

The process in which the dispenser verifies the identity of the hydrogen-fueled mobility using a public key in the aforementioned TLS will be described by way of examples below.

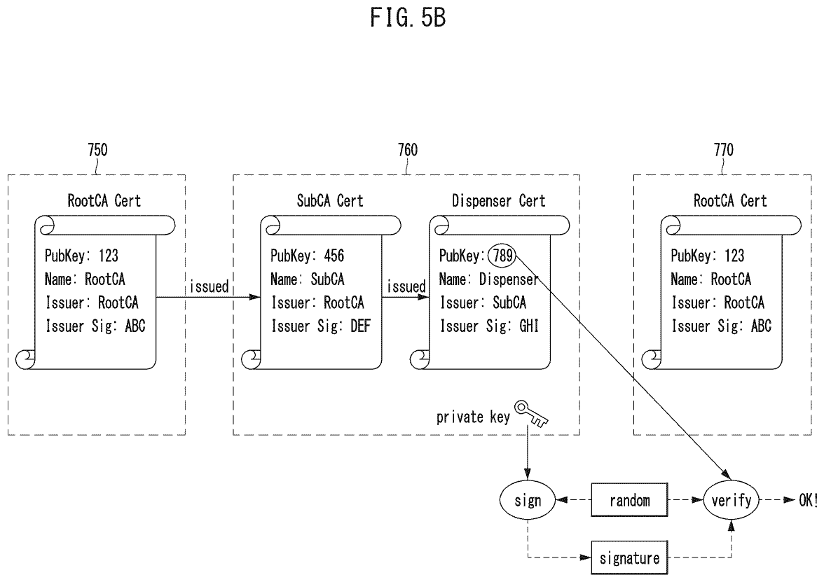

FIGS. 5A and 5B are exemplary diagrams for explaining key principles of public key infrastructure (PKI), which may be applied to the hydrogen fuel supply communication method of the present embodiment.

As shown in FIG. 5A, a root certificate authority (hereinafter simply referred to as “root CA”) 750 generates a root certificate (RootCA Cert), and issues a subordinate certificate (SubCA Cert) generated by the root CA 750 in response to a certificate issuance request from a specific dispenser 760, and may distribute the root certificate (RootCA Cert) to entities such as hydrogen-fueled mobility 770. The root certificate (RootCA Cert) or the subordinate certificate (SubCA Cert) may include a public key (PubKey), certificate name, issuer, and issuer signature.

The dispenser 760 may generate a dispenser certificate (Dispenser Cert) using the subordinate certificate and dispenser's own private key. The issuer of the dispenser certificate may be a HFO subordinate certification authority (SubCA) of the V2D root certificate authority (V2D RootCA) 750. The issuer signature of the dispenser certificate may be verified using the public key of the subordinate certificate.

In addition, the issuer signature of the subordinate certificate may be verified using the public key of the root certificate held by the hydrogen-fueled mobility 770. This may correspond to a process in which the hydrogen-fueled mobility 770 authenticates itself to the dispenser 760 using an OEM provisioning certificate.

Next, as shown in FIG. 5B, the dispenser 760 may encrypt a message using its own randomly generated private key and the public key of the hydrogen-fueled mobility, which is the recipient, and may additionally encrypt the randomly generated private key with the recipient's public key to transmit both the encrypted message and the encrypted private key. Then, the hydrogen-fueled mobility may verify the received message or the signature of the message by decrypting the received message or the signature of the message with its own public key, i.e., the public key (for example, 789) of the dispenser certificate.

As such, the dispenser 760 may verify the identity of the hydrogen-fueled mobility 770 based on the public key of the root CA, and the dispenser 760 may verify its own identity based on the public key of the root CA. The hydrogen-fueled mobility 770 may verify the identity of the dispenser 760 based on the public key of the root CA.

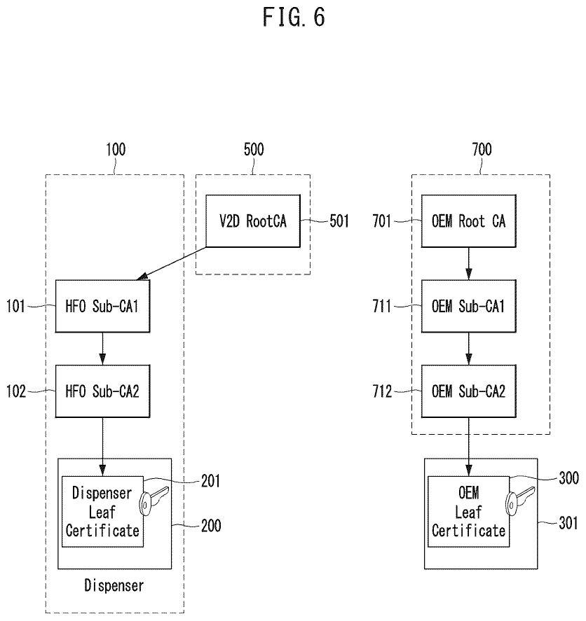

FIG. 6 is an exemplary diagram illustrating a PKI structure that may be employed in the hydrogen fuel supply communication method according to exemplary embodiments of the present disclosure.

As shown in FIG. 6, the PKI structure of the present embodiments is for the fuel supply service of hydrogen-fueled mobility, and includes a hydrogen fueling operator (HFO) 100, a hydrogen-fueled mobility 300, a trust service provider 500, and an original equipment manufacturer (OEM) 700.

The trust service provider 500 may be referred to as a trust anchor and may include a vehicle-to-device root certificate authority (V2D RootCA) 501. The V2D RootCA 501 may self-sign information such as its own public key and identification information with its own private key, and may issue a V2D root certificate including the signature value and the signed information. In addition, the V2D RootCA 501 may sign information such as the public key, identification information, etc. of a first HFO subsequent/subordinate certificate authority (HFO Sub-CA1) 101 with its own private key and generate a first HFO subordinate certificate including the signature value and the signed information.

The hydrogen fueling operator (HFO) 100 may include the first HFO Sub-CA 101, a second HFO Sub-CA 102, and a dispenser 200.

The first HFO Sub-CA 101 may sign information such as the public key, identification information, etc. of the second HFO Sub-CA 102 with its own private key and generate a second HFO subordinate certificate including the signature value and the signed information.

The second HFO Sub-CA 102 may sign information such as the public key, identification information, etc. of the dispenser 200 with its own private key and generate a dispenser leaf certificate (Dispenser Leaf Cert.) 201 including the signature value and the signed information. The dispenser leaf certificate 201 may be used to verify the signature of a request message in response to a certificate installation request for the dispenser 200 from entities such as hydrogen-fueled mobility 300, and may be used to uniquely identify the corresponding dispenser during lifetime thereof.

The dispenser 200 may load the dispenser leaf certificate 201 into its control device or store the dispenser leaf certificate 201 in internal storage thereof.

The OEM 700 includes the manufacturer of the hydrogen-fueled mobility.

The OEM 700 may include an OEM root certificate authority (OEM RootCA) 701 that issues OEM root certificates and may operate subordinate certificate authorities (OEM Sub-CA1, OEM Sub-CA2), or the like.

The OEM root certificate authority (OEM RootCA) 701 may self-sign its own public key and identification information using its private key to generate an OEM root certificate that includes the signature value and the signed information. In addition, the OEM RootCA 701 may sign the public key and identification information of a first OEM subsequent/subordinate certificate authority (OEM Sub-CA1) 711 using its private key to generate an OEM first subordinate certificate that includes the signature value and the signed information.

The first OEM subsequent/subordinate certificate authority 711 may sign the public key and identification information of a second OEM subsequent/subordinate certificate authority (OEM Sub-CA2) 712 using its private key to generate an OEM second subordinate certificate that includes the signature value and the signed information.

The second OEM subsequent/subordinate certificate authority 712 may sign information such as the public key and identification information of the HFM 300 using its private key to generate an OEM provisioning certificate 301 that includes the signature value and the signed information when a hydrogen-fueled mobility (HFM) 300 is manufactured.

The OEM provisioning certificate (OEM Prov Cert.) 301 may be used by the OEM 700, the OEM root certificate authority, or an OEM subsequent/subordinate certificate authority to verify the signature of a certificate installation request message from the hydrogen-fueled mobility 300, and may be used to uniquely identify the hydrogen-fueled mobility 300 throughout lifetime thereof. The OEM provisioning certificate 301 may be mounted on a control device or storage device of the hydrogen-fueled mobility 300.

The PKI structure of the present embodiments omits contract authorization, contract authentication, certificate installation service, plug and charge (PnC) automatic authentication for hydrogen fuel supply service users, and billing. However, the present disclosure is not limited thereto and may include contract authentication, certificate installation service, automatic authentication, billing, or any combination thereof.

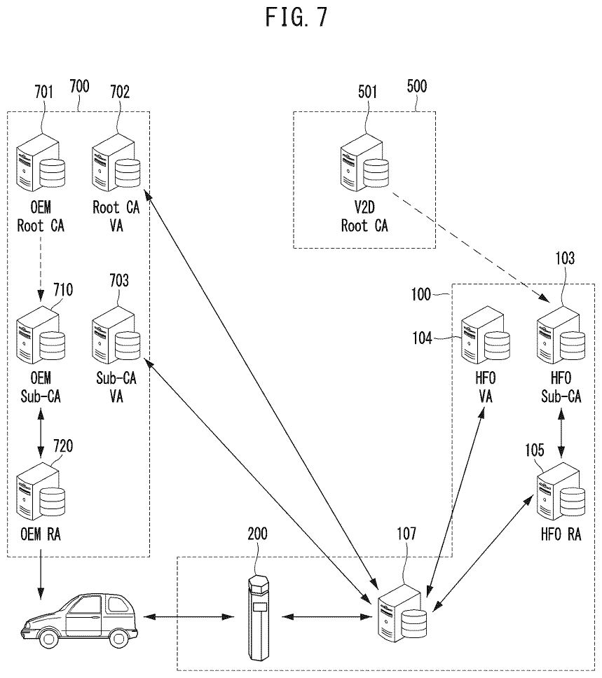

FIG. 7 is an exemplary diagram of a hydrogen fuel supply ecosystem to which a hydrogen fuel supply communication method according to exemplary embodiments of the present disclosure may be applied.

As shown in FIG. 7, the hydrogen fuel supply ecosystem of the present embodiments is for providing a fuel supply service for hydrogen-fueled mobility, and may include a hydrogen fueling operator (HFO) 100, a hydrogen-fueled mobility 300, a trust service provider 500, and an original equipment manufacturer (OEM) 700.

The trust service provider 500 may be referred to as a trust service provider or a V2D (Vehicle to Device) operator, and may include a Vehicle to Device Root Certificate Authority (V2D RootCA) 501. The V2D RootCA 501 may self-sign its own public key and identification information using its private key, and may issue a V2D root certificate that includes the signature value and the signed information.

In addition, the V2D RootCA 501 may sign the public key and identification information of an HFO subsequent/subordinate certificate authority (HFO Sub-CA) 103 of the hydrogen fueling operator (HFO) 100 using its private key to generate an HFO subordinate certificate that includes the signature value and the signed information.

The hydrogen fueling operator (HFO) 100 may include the HFO Sub-CA 103, an HFO validation authority (HFO VA) 104, an HFO registration authority (HFO RA) 105, and a dispenser management system 107. In a broader sense, the hydrogen fueling operator 100 may include a dispenser 200.

The HFO Sub-CA 103 may store, issue, and sign digital certificates. The HFO Sub-CA 103 may cooperate and/or share information with the HFO registration authority 105 to sign the public key and identification information of the dispenser 200 using its private key, and may issue a dispenser leaf certificate to the dispenser 200 that includes the signature value and the signed information.

The HFO registration authority (HFO RA) 105 may act as a public key infrastructure entrusted by certificate authorities such as the HFO Sub-CA, in order to ensure the valid and proper registration of the dispenser 200. The HFO RA 105 is responsible for receiving requests for digital certificates for the dispenser 200 from the dispenser management system 107 and authenticating the entity requesting the certificate. The HFO RA 105 may be configured to perform identification and authentication of certificate applicants such as the dispenser management system 107 and the dispenser 200; to approve or deny certificate applications; to initiate certificate revocation or suspension under specific conditions; to process subscriber requests for certificate revocation or suspension; and to approve or deny subscriber requests for certificate renewal or key regeneration.

Additionally, the HFO registration authority 105 may be configured to sign or issue certificates. That is, the HFO registration authority 105 may be entrusted to perform specific tasks such as certificate issuance on behalf of the HFO subsequent/subordinate certificate authority 103. In this case, the dispenser 200 may receive a dispenser leaf certificate through the dispenser management system 107 and the HFO registration authority 105.

The HFO validation authority (HFO VA, 104) may be configured to verify the validity period of certificates such as dispenser leaf certificates and contract certificates. The HFO validation authority 104 may verify the validity period of a certificate based on the time of the dispenser management system (DMS time) or the time of the dispenser (dispenser time), which may refer to the time of the dispenser controller or the dispenser communication controller.

Additionally, in case that the HFO validation authority 104 fails to validate a signature, contract certificate, or dispenser leaf certificate, the HFO validation authority 104 may deliver a result to the dispenser management system 107 indicating that the corresponding signature or certificate is invalid. In such a case, the invalidated signature or certificate may no longer be used.

The dispenser management system (DMS) 107 manages at least one dispenser 200 and may perform procedures such as issuance, renewal, and validation of signatures or certificates related to the dispenser 200, in cooperation with the HFO validation authority 104 and the HFO registration authority 105, based on the request of the dispenser 200.

The dispenser 200 may use the HFO validation authority 104, connected via the dispenser management system 107, for the purpose of validating contract certificates or signatures such as dispenser leaf certificates, in association with the hydrogen fueling operator (HFO) 100.

Additionally, the dispenser 200 may have its identity verified by the hydrogen-fueled mobility 300 based on the dispenser leaf certificate and its own dispenser certificate issued using the dispenser leaf certificate. That is, the dispenser leaf certificate may be used to verify the signature of a request message in response to a certificate installation request from the dispenser 200, and may be used to uniquely identify the corresponding dispenser throughout lifetime thereof. The dispenser leaf certificate may be mounted on a control device of the dispenser 200 or stored in its internal storage.

The OEM 700 includes the manufacturer of the hydrogen-fueled mobility. The OEM 700 includes an OEM root certificate authority (OEM RootCA) 701 that issues OEM root certificates, and may operate a subsequent/subordinate certificate authority (OEM Sub-CA) 710. Additionally, the OEM 700 may operate an OEM registration authority (OEM RA) 720, a root CA validation authority (RootCA VA) 702, and a subordinate CA validation authority (Sub-CA VA) 703.

The OEM root certificate authority 701 may self-sign its own public key and identification information using its private key to generate an OEM root certificate that includes the signature value and the signed information. The OEM root certificate authority 701 may also sign the public key and identification information of the OEM subsequent/subordinate certificate authority (OEM Sub-CA) 710 using its private key to generate an OEM subordinate certificate that includes the signature value and the signed information.

The OEM subsequent/subordinate certificate authority 710 may sign the public key and identification information of the HFM 300 using its private key to generate an OEM provisioning certificate that includes the signature value and the signed information when a hydrogen-fueled mobility (HFM) 300 is manufactured. The public key and identification information of the HFM 300 may be extracted from the registration information created or entered at the time of registration with the OEM registration authority (OEM RA) 720.

The OEM provisioning certificate may be used by the OEM 700, the OEM root certificate authority, or the OEM subsequent/subordinate certificate authority to verify the signature of a certificate installation request message from the hydrogen-fueled mobility 300, and may be used to uniquely identify the hydrogen-fueled mobility 300 throughout lifetime thereof. The OEM provisioning certificate may be mounted on a control device or storage device of the hydrogen-fueled mobility 300.

When receiving hydrogen fuel supply service from the dispenser 200, the hydrogen-fueled mobility 300 may encrypt the OEM provisioning certificate with its private key and transmit the encrypted the OEM provisioning certificate to the dispenser 200, or may encrypt a hydrogen fuel supply request message or a signature with its private key and transmit the encrypted hydrogen fuel supply request message or the encrypted signature to the dispenser 200. In this case, the dispenser management system 107 connected to the dispenser 200 may verify the identity of the hydrogen-fueled mobility 300 through the OEM root CA validation authority 702 and/or the OEM subordinate CA validation authority 703.

Additionally, the hydrogen-fueled mobility 300 may verify the identity of the dispenser 200 by verifying the issuer of the root CA subordinate certificate stored in the dispenser 200, using the pre-distributed OEM root certificate.

The PKI structure of the present embodiments omits contract authentication, certificate installation service, plug and charge (PnC) automatic authentication for hydrogen fuel supply service users, and billing. However, the present disclosure is not limited thereto and may include contract authentication, certificate installation service, automatic authentication, billing, or any combination thereof.

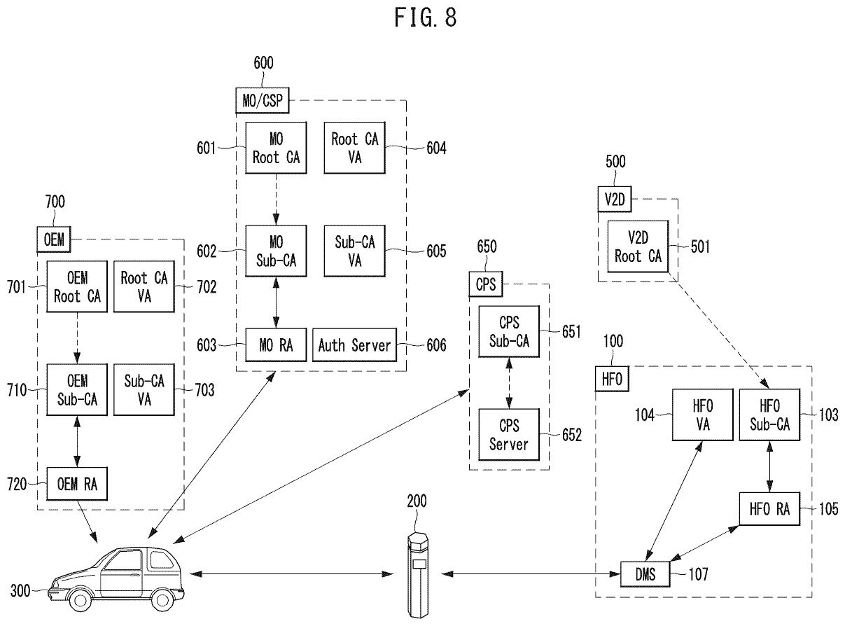

FIG. 8 is an exemplary diagram of a hydrogen fuel supply ecosystem for explaining a hydrogen fuel supply communication method according to another exemplary embodiments of the present disclosure.

As shown in FIG. 8, the hydrogen fuel supply ecosystem of these embodiments is intended to provide hydrogen fuel supply services from hydrogen infrastructure to hydrogen-fueled mobility, and may include a hydrogen fueling operator (HFO) 100, hydrogen-fueled mobility 300, a trust service provider for V2D 500, a mobility operator (MO) 600, a certificate provisioning service provider 650, and an original equipment manufacturer (OEM) 700. The mobility operator 600 may include a charge service provider (CSP) that operates hydrogen fueling stations or the like. In a broad sense, the hydrogen fueling operator 100 may include a dispenser 200.

The trust service provider 500 may function as a V2D (Vehicle to Device) operator and may include a Vehicle to Device Root Certificate Authority (V2D RootCA) 501. The V2D RootCA 501 may self-sign its own public key and identification information using its private key to issue a V2D root certificate including the signature value and the signed information.

Additionally, the V2D RootCA 501 may sign the public key and identification information of the HFO subsequent/subordinate certificate authority (HFO Sub-CA) 103 with its private key to generate an HFO subordinate certificate including the signature value and the signed information.

The hydrogen fueling operator (HFO) 100 may include an HFO subsequent/subordinate certificate authority 103, an HFO validation authority (HFO VA) 104, an HFO registration authority (HFO RA) 105, and a dispenser management system 107.

As the HFO Sub-CA 103, HFO VA 104, HFO RA 105, DMS 107, and dispenser 200 have already been described with reference to FIG. 7, their descriptions will be omitted here to avoid redundancy.

The OEM (700) includes the manufacturer of the hydrogen-fueled mobility. The OEM (700) includes an OEM root certificate authority (OEM RootCA) 701 that issues OEM root certificates and may operate subordinate certificate authorities (OEM Sub-CA1, OEM Sub-CA2).

The OEM RootCA 701 may self-sign its own public key and identification information using its private key to generate an OEM root certificate including the signature value and the signed information. In addition, the OEM RootCA 701 may sign the public key and identification information of the first OEM subsequent/subordinate certificate authority (OEM Sub-CA1) 711 with its private key to generate an OEM first subordinate certificate including the signature value and the signed information.

The first OEM Sub-CA 711 may sign the public key and identification information of the second OEM subsequent/subordinate certificate authority (OEM Sub-CA2) 712 with its private key to generate an OEM second subordinate certificate including the signature value and the signed information.

The second OEM Sub-CA 712 may sign the public key and identification information of the HFM 300 with its private key to generate an OEM provisioning certificate including the signature value and the signed information when the hydrogen-fueled mobility 300 is manufactured.

The mobility operator (MO) 600 functions as a root certificate authority (MO RootCA, 601) that issues MO root certificates, and may operate an MO subsequent/subordinate certificate authority (MO Sub-CA) 602. The MO 600 may further include an MO registration authority (MO RA) 603, an MO RootCA validation authority (Root CA VA) 604, an MO Sub-CA validation authority (Sub-CA VA) 605, and an authentication server (Auth Server) 606.

The MO 600 may generate an MO subordinate certificate by appending its own signature to the identifier (ID) and public key of the MO Sub-CA 602. The MO subordinate certificate may be referred to as an MO intermediate chain certificate. When multiple MO subordinate certificate authorities exist, a plurality of MO intermediate chain certificates may be generated in a sequential chain format. For example, the first MO Sub-CA may generate an MO second intermediate chain certificate by signing the ID and public key of the second subordinate CA.

The MO registration authority 603 may collect and manage information such as the public key and identification information of the hydrogen-fueled mobility 300 and/or its owner for the purpose of contracts related to hydrogen fuel supply services.

The MO validation authorities 604 and 605 may verify the identity of the hydrogen-fueled mobility 300 and/or its owner, or verify the contract with the owner of the hydrogen-fueled mobility in accordance with a predetermined agreement.

The authentication server 606 may authenticate the suitability and validity of the contract and/or the contract certificate established between the hydrogen-fueled mobility 300 and/or its owner.

When the hydrogen-fueled mobility is shipped, the MO Sub-CA 602 may use the private key paired with the public key included in the MO intermediate chain certificate to generate a contract certificate based on the contract established between the MO and the hydrogen-fueled mobility owner. In addition, the hydrogen-fueled mobility may install the contract certificate through the first-visited hydrogen fueling operator. The contract certificate may be linked to the hydrogen-fueled mobility owner's payment account via a unique identifier called an e-Mobility Authentication Identifier (eMAID).

Meanwhile, the certificate provisioning service (CPS) provider 650 provides certificate provisioning services to the hydrogen infrastructure, particularly to the MO 600 and hydrogen-fueled mobility 300, and may operate a CPS subsequent/subordinate certificate authority (CPS Sub-CA, 651). The CPS provider 650 may also include a CPS server 652.

When the certificate provisioning service is provided online through the dispenser 200, the mobility operator (MO) 600 may deliver credentials to the hydrogen-fueled mobility 300 via the certificate provisioning service. The certificate provisioning service may verify the accuracy and trustworthiness of the credentials through a signature and transmit the signed message fragment to the dispenser 200 or to the dispenser communication controller.

The dispenser communication controller may compile a certificate installation response message and transmit the compiled certificate installation response message to the hydrogen-fueled mobility (HFM) 300 or to the HFM communication controller. In this embodiment, the certificate provisioning service is assumed to be trusted. Accordingly, the HFM communication controller may verify the contract certificate received through the certificate installation response message via the public key infrastructure.

The certificate provisioning service may be configured to sign a specific element of the certificate installation response message, such as the SignedInstallationData element, using a private key associated with a CPS leaf certificate issued by the CPS subordinate certification authority (CPS Sub-CA) 651. This indicates that the CPSCertificateChain field must include a certificate chain for verifying the signature. The certificate provisioning service may verify whether the data included in the signature was received from the preceding secondary actor in an authenticated manner.

All subordinate certificates of the provisioning subordinate certificate authorities may be signed by the V2D RootCA 501 for the purpose of certificate provisioning services. The leaf certificate provisioning key pair may be authenticated by the V2D RootCA 501 for use in the certificate provisioning service.

Meanwhile, the V2D entity 500, which serves as the root certification authority of the hydrogen fueling operator, or the V2D root server (hereinafter referred to as the “global root server”), may generate certificates independently of those used by other actors, based on the V2D root certificate or the global root certificate. The global root server, corresponding to the V2D RootCA, may issue OEM provisioning certificates and contract certificates using the V2D root certificate in place of the OEM 700 and MO 600 root certificates. Furthermore, the global root server may generate at least two certificate chains: one for the hydrogen fueling operator 100 and the dispenser 200, and another for the certificate provisioning service (CPS). That is, the OEM provisioning certificate and the contract certificate may be generated based on root certificates individually generated by the OEM 700 and MO 600, respectively.

In the above-described embodiments, the dispenser 200 is provided with a communication controller (hereinafter referred to as “first communication controller”), which may be referred to as a dispenser communication controller or a supply equipment communication controller (SECC). The hydrogen-fueled mobility 300 is also provided with a communication controller (hereinafter referred to as “second communication controller”), which may be referred to as a hydrogen-fueled mobility communication controller, hydrogen vehicle communication controller, or electric vehicle communication controller (EVCC).

The configurations applied to security in hydrogen fuel supply communication between entities in the hydrogen infrastructure are summarized in Table 1. The hydrogen fuel supply communication may include not only the communication related to hydrogen fuel supply between the hydrogen-fueled mobility and the dispenser, but also all communications related to hydrogen fuel supply among entities of the hydrogen infrastructure.

TABLE 1

| Security | Technical | | |
|---|---|---|---|
| Objective | Classification | Usage | Related Sessions |
| Confidentiality | Key Exchange | ECDH | TLS 1.3 Handshake |
| | | | One-pass ECDH for private key |
| | | | installation |
| | | | Dual curves |
| | Authenticated | AES-256-GCM | TLS 1.3 Data Communication |
| | Encryption | | Encryption of user private key |
| Integrity | Authenticated | ASE-256-GCM | TLS 1.3 Data Communication |
| | Encryption | | |
| Authentication/ | Digital Signature | ECDSA | Contract authorization |
| Non-repudiation | | Ed448 | Mutual authentication via TLS 1.3 |
| | | | Handshake |
| | | | Sales tariff |
| | | | Metering receipt request |
| | | | Certificate installation request |
| | | | Certificate installation response |
| Message | Hash Function | SHA512 | Used for HMAC and signatures |
| Digest | | | |

As shown in Table 1, in the hydrogen fuel supply communication between the hydrogen-fueled mobility (or EVCC) and the dispenser (or SECC), the EVCC and SECC may perform a TLS 1.3 handshake based on Elliptic-curve Diffie-Hellman (ECDH) for confidentiality in key exchange. The handshake may be configured to perform session setup requests/responses, service discovery requests/responses, and service detail requests/responses between the EVCC and SECC using private key encryption.

Additionally, in the hydrogen fuel supply communication between the EVCC and the MO, the EVCC and MO may exchange messages based on one-pass ECDH for confidentiality in key exchange and for session key agreement or installation of a private key.

Moreover, an entity of the hydrogen infrastructure may support signing operations using the EdDSA (Edwards-curve Digital Signature Algorithm), which uses the Ed448 elliptic curve algorithm, i.e., Curve448 or Curve448-Goldilocks. That is, when an entity of the hydrogen infrastructure selects a curve or key corresponding to an elliptic curve cryptography (ECC) signature algorithm, the input parameters for the concatenation key derivation function (KDF), which includes the shared secret, may be derived according to “Elliptic Curves for Security” defined in IETF RFC 7748. For example, the KDF input parameter may be set to 255 for the X25519 curve or 448 for the X448 curve.

In particular, in this embodiment, an entity of the hydrogen infrastructure may use dual curves as the elliptic curves corresponding to the ECC signature algorithm to enhance confidentiality in key exchange. The dual curves may include the P-521 (secp521r1) elliptic curve and the Ed448 elliptic curve. Such dual curves may be used for encrypting subject public key information in certificates such as HFO subordinate certificates and dispenser leaf certificates.

Furthermore, in order to enhance confidentiality and integrity through authenticated encryption, TLS 1.3 data communication based on AES-256-GCM (Galois/Counter Mode) may be performed between the EVCC and SECC in hydrogen fuel supply communication. Also, to enhance confidentiality through authenticated encryption, the private key of the user may be encrypted based on AES-256-GCM in hydrogen fuel supply communication between the EVCC and MO 600.

For authentication or non-repudiation via digital signature, an ECDSA-based cryptographic algorithm may be used for contract authorization from the hydrogen-fueled mobility 300 to the dispenser 200; TLS 1.3 handshake from the dispenser 200 to the hydrogen-fueled mobility 300; sales tariff delivery from the MO 600 to the hydrogen-fueled mobility 300; metering receipt request message from the hydrogen-fueled mobility to the MO; certificate installation request message from the hydrogen-fueled mobility 300 to the certificate provisioning service provider 650; and certificate installation response message from the certificate provisioning service provider 650 to the hydrogen-fueled mobility 300.

Here, the TLS 1.3 handshake transmitted from the dispenser 200 to the hydrogen-fueled mobility 300 may be configured to support mutual authentication using the certificate of the hydrogen-fueled mobility. The certificate of the hydrogen-fueled mobility may include one or more of: a leaf provisioning certificate, a contract certificate, an OEM provisioning certificate, or a private-environment TLS certificate.

In addition, the hydrogen-fueled mobility 300 and the dispenser 200 may each use a hash-based message authentication code (HMAC) and a signature for a message digest that is message compression. Each of the hydrogen-fueled mobility 300 and the dispenser 200 may use SHA (Secure Hash Algorithm), preferably SHA-512, as the hash function for generating the HMAC. For example, a concatenation key derivation function (KDF) with SHA-512 as the hash function may be used.

For example, the key derivation function (KDF) is a “concatenation key derivation function” that uses SHA-512 as the hash function. When a curve corresponding to an ECC signature algorithm is selected, the input parameters of the KDF, which includes a shared secret, may be derived according to “Elliptic Curves for Security” as defined in IETF RFC 7748. In this context, the secondary actor plays the role of the first party (U) and the hydrogen-fueled mobility (or EVCC) plays the role of the second party (V), as defined in NIST documentation. The protocol may use predefined elliptic curves. The algorithm ID may be a single character, 0x01. The sender name ID (U) may be the single character “U”=0x55, and the receiver name ID (V) may be the single character “V”=0x56. In this case, a symmetric encryption key of exactly 256 bits or exactly 512 bits may be derived.

Meanwhile, the PKI structure of these embodiments may omit contract authentication, certificate installation service, plug and charge (PnC) automatic authentication for hydrogen fuel supply service users, and billing. However, the present disclosure is not limited thereto and may include contract authentication, certificate installation service, automatic authentication, billing, or any combination thereof.

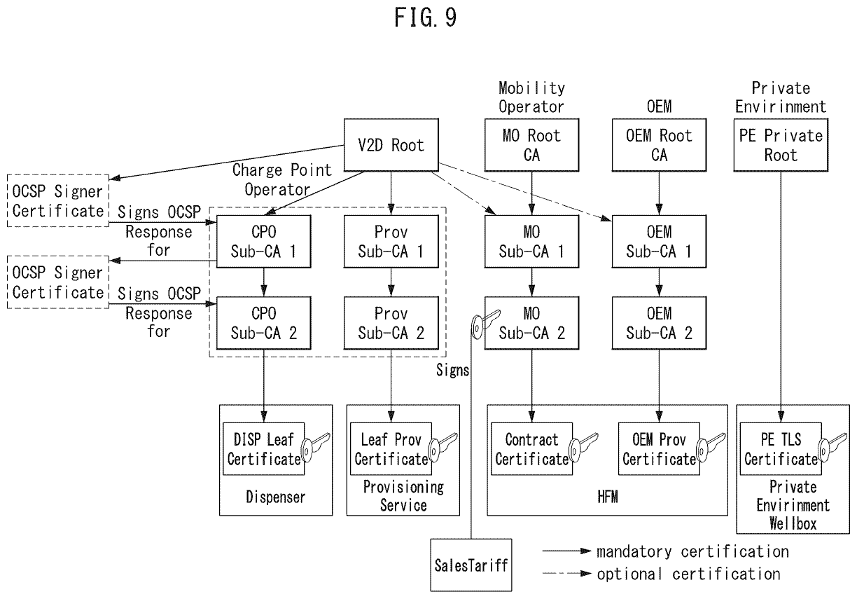

FIG. 9 is an exemplary diagram for explaining a hydrogen fuel supply procedure with cross-signing for illustrating a security method in hydrogen fuel supply communication according to another exemplary embodiments of the present disclosure.

The security method of these embodiments demonstrates a public key infrastructure (PKI) applicable to a plug and charge (PnC) architecture for hydrogen fuel supply users employed in the hydrogen infrastructure.

As shown in FIG. 9, the public key infrastructure necessary to activate PnC provides a framework for identity verification of individuals or devices, enabling confidential communication and ensuring controlled access to resources. This framework includes the PKI structure.

In detail, the original equipment manufacturer (OEM) functions as a root certificate authority (OEM Root CA) issuing OEM root certificates for hydrogen-fueled mobility (HFM) and operates subordinate certificate authorities (OEM Sub-CA1, OEM Sub-CA2). The OEM Root CA may generate an OEM root certificate and append signature thereof to the identifier and public key of OEM Sub-CA1 to generate an OEM first intermediate chain certificate.

When the EV is manufactured, the second OEM subsequent/subordinate certificate authority (OEM Sub-CA2), which is the last CA in the OEM intermediate chain, may use the private key paired with the public key included in the OEM second intermediate certificate to generate an OEM provisioning certificate, which may be installed in the hydrogen-fueled mobility (HFM). The OEM provisioning certificate may be used to verify the signature of a certificate installation request message and may be used to uniquely identify the HFM throughout lifetime thereof.

The mobility operator (MO) functions as a root certificate authority (MO Root CA) that issues MO root certificates and may operate at least one MO subsequent/subordinate certificate authority. The MO may generate an MO first intermediate chain certificate by appending its own signature to the identifier (ID) and public key of MO Sub-CA1. MO Sub-CA1 may generate an MO second intermediate chain certificate by appending signature thereof to the ID and public key of MO Sub-CA2.

When the EV is delivered, the MO Sub-CA2 may generate a contract certificate using the private key paired with the public key included in the MO second intermediate chain certificate, based on the contract established between the MO and the HFM owner. The contract certificate may be installed in the hydrogen-fueled mobility, for example, through the first-visited hydrogen fueling operator. The contract certificate may be linked to the payment account of the HFM owner via a unique identifier called the e-Mobility Authentication Identifier (eMAID).

The OEM provisioning certificate and the contract certificate may be generated based on root certificates independently generated by the OEM and MO, respectively. Furthermore, the OEM provisioning certificate and the contract certificate may also be generated based on the V2D root certificate or global root certificate of the top-level V2D server (the “global root server”) in the hydrogen infrastructure and may be independent from certificates used by other actors.

Meanwhile, the global root server may issue the OEM provisioning certificate (OEM Prov Cert.) and the contract certificate using the V2D root certificate instead of the root certificates of the OEM and MO (see the dotted arrows in FIG. 9).

The global root server may also generate at least two certificate series or certificate chains: one for the charge point operator (CPO) and dispenser, and another for the provisioning service. The charge point operator (CPO) may include the hydrogen fueling operator (HFO).

Specifically, the global root server may issue a CPO first intermediate chain certificate by appending signature thereof to the ID and public key of the first CPO subsequent/subordinate certificate authority (CPO Sub-CA1). CPO Sub-CA1 may issue a CPO second intermediate chain certificate by appending signature thereof to the ID and public key of the second CPO subsequent/subordinate certificate authority (CPO Sub-CA2).

CPO Sub-CA2 may issue a dispenser leaf certificate using the private key paired with the public key included in the CPO second intermediate chain certificate. In other words, CPO Sub-CA2 may issue a dispenser leaf certificate by appending digital signature thereof to the dispenser ID and public key received from a dispenser or dispenser management system.

The dispenser leaf certificate may be used by the hydrogen fueled mobility during TLS setup in hydrogen fueling communication to verify that the hydrogen fueled mobility is communicating with a legitimate dispenser rather than a counterfeit one. This certificate may also be issued to a backend server of the hydrogen fueling operator (HFO), as well as to the dispenser itself.

The global root server may also issue a provisioning first intermediate chain certificate by appending signature thereof to the ID and public key of the first provisioning subsequent/subordinate certificate authority (Prov Sub-CA1) under the CPO. Prov Sub-CA1 may issue a provisioning second intermediate chain certificate by appending signature thereof to the ID and public key of the second provisioning subsequent/subordinate certificate authority (Prov Sub-CA2).

CPO Sub-CA2, functioning as the second intermediate provisioning authority, may issue a leaf provisioning certificate using the private key paired with the public key included in the provisioning second intermediate chain certificate. This certificate may be delivered to the HFM by the certificate provisioning service (CPS) for installation.

Each root certificate authority (V2D RootCA, MO RootCA, OEM RootCA) may issue an online certificate status protocol (OCSP) certificate or a certificate revocation list (CRL) to clients, including entities in the hydrogen infrastructure. In this case, clients may connect to the OCSP server to request and receive revocation status information regarding the validity of counterpart certificates, based on OCSP or CRL.

Although FIG. 9 shows OCSP certificates only in connection with CPO subordinate certificate authorities (CPO Sub-CA1, CPO Sub-CA2) for simplicity, all root certificate authorities (V2D RootCA, MO RootCA, OEM RootCA) may issue OCSP certificates for validity checks of certificates in their own root certificate chains. Also, a private environment (PE) root (PE private Root) may install a PE TLS certificate into a PE wallbox.

Meanwhile, in the present embodiment, the dispenser or the dispenser management system may provide the hydrogen fueled mobility with a list of mobility operators (MOs) that support plug and charge (PnC) of the hydrogen fueling operator. Based on this, the hydrogen fueled mobility may recognize in advance the MOs that can be authorized at the dispenser and may transmit a contract certificate supported by the corresponding MO to the dispenser, thereby allowing the PnC procedure to be executed quickly and accurately.

In particular, the hydrogen fuel supply communication that includes the PnC procedure may effectively provide a secure environment for confidential communication through the public key infrastructure described in Table 1.

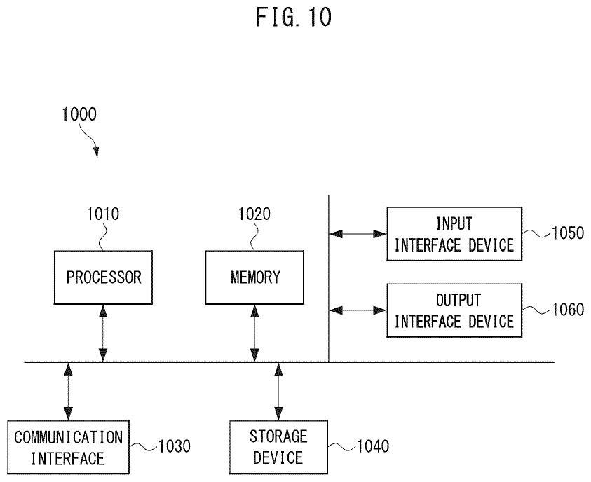

FIG. 10 is a schematic block diagram of a security device for performing a security method in hydrogen fuel supply communication according to another exemplary embodiments of the present disclosure.

As shown in FIG. 10, the security device 1000 may be mounted in or coupled with one or more of the hydrogen-fueled mobility, the dispenser, or the dispenser management system.

The security device 1000 may include a processor 1010 that performs security procedures in hydrogen fuel supply communication between the hydrogen-fueled mobility and the hydrogen infrastructure. The processor 1010 may be implemented as the EVCC of the hydrogen-fueled mobility, the SECC of the dispenser, or the controller of the dispenser management system.

Additionally, the security device 1000 may further include one or more of a memory 1020, a transceiver 1030, or a storage device 1040, depending on the implementation. The security device 1000 may also include an input interface device 1050, an output interface device 1060, or an input/output interface device. The components of the security device 1000 may be connected via a common or individual bus to communicate with each other.

The processor 1010 may execute program instructions stored in the memory 1020 and/or the storage device 1040. The program instructions may implement at least one procedure of the security method for hydrogen fuel supply communication between the hydrogen-fueled mobility and the hydrogen infrastructure.

The processor 1010 may include at least one central processing unit (CPU), graphics processing unit (GPU), or another processor capable of performing the security method according to the present disclosure.

The memory 1020 may store program instructions or software modules. The memory 1020 may include volatile memory such as random access memory (RAM) and non-volatile memory such as read-only memory (ROM). The memory 1020 may be configured to load program instructions stored in the storage device 1040 and provide them to the processor 1010 for execution.

The storage device 1040, as a recording medium suitable for storing program instructions and data, may include magnetic media such as hard disks, floppy disks, and magnetic tapes; optical media such as CD-ROMs and DVDs; magneto-optical media such as floptical disks; and semiconductor memory such as flash memory, EPROM (erasable programmable ROM), or solid-state drives (SSDs) based on any of the above.

When executed by the processor 1010, the program instructions may include at least one instruction for causing the processor 1010 to perform a specific operation or function. The at least one instruction may be one or more of an instruction for a TLS 1.3 handshake between the EVCC and SECC; an instruction for TLS 1.3 data communication between the EVCC and SECC; an instruction for contract certificate authentication between the EVCC and SECC; an instruction for the SECC to perform mutual authentication using a mobility certificate in a TLS 1.3 handshake; an instruction for HMAC and signature operations by the EVCC or SECC; an instruction for private key installation based on one-pass ECDH between the EVCC and the mobility operator; an instruction for encrypting a user's private key between the EVCC and the mobility operator; an instruction for the mobility operator to deliver a sales tariff to the EVCC; an instruction for the EVCC to request a metering receipt from the mobility operator; a session-related instruction for dual curves corresponding to ECC curves/keys; an instruction for the EVCC to handle a certificate installation request to the CPS; or an instruction for the CPS to handle a certificate installation response to the EVCC.

The transceiver 1030 may include a wireless local area network (WLAN) interface, a programmable logic controller (PLC) module, a peer-to-peer signaling (P2PS) controller, a gateway (G/W), or a communication subsystem comprising a combination thereof, and may be configured to transmit and receive signals and data with at least one external device. The WLAN interface may include an interface for Wi-Fi communication.

Meanwhile, the method described in the above embodiments may be implemented as a program or code stored on a computer-readable recording medium. The computer-readable recording medium includes all types of storage devices where data readable by a computer system is stored. Furthermore, the computer-readable recording medium may include distributed storage in a network-connected computer system, where a computer-readable program or code is stored and executed in a distributed manner.

The computer-readable recording medium may include hardware devices such as ROM, RAM, and flash memory specifically configured to store and execute program instructions. The program instructions may include not only machine language code created by a compiler but also high-level language code executable by a computer using an interpreter or the like.

Some aspects of the present disclosure have been described in the context of a device, but may alternatively be described in terms of corresponding methods. That is, a block or device may correspond to a method step or feature of a method step. Likewise, aspects described in the context of a method may be represented as corresponding blocks, modules, or features of a corresponding device. Some or all of the method steps may be performed by (or using) hardware devices such as a microprocessor, a programmable computer, or electronic circuitry. In some embodiments, one or more of the most critical method steps may be performed by such devices.

In the embodiments, programmable logic devices, such as a field-programmable gate array (FPGA), may be used to perform some or all of the functions of the described methods. The FPGA may operate in conjunction with a microprocessor to perform one of the methods described herein.

While the preferred embodiments of the present disclosure have been described above with reference to the accompanying drawings, those skilled in the art will understand that various modifications and changes may be made without departing from the spirit and scope of the invention as set forth in the appended claims.

1. A hydrogen fueling communication method by a hydrogen fueling operator (HFO), comprising:
receiving, from an upper root server, a first subordinate certificate that includes a signature value and signed information, the signature value generated by signing a public key and identification information of a first subsequent certificate authority of the HFO using a private key of the upper root server;
generating, by the first subsequent certificate authority, a second subordinate certificate that includes a signature value and signed information, the signature value generated by signing a public key and identification information of a second subsequent certificate authority using the private key of the first subsequent certificate authority; and
issuing, by the second subsequent certificate authority, a dispenser leaf certificate that includes a signature value and signed information, the signature value generated by signing a public key and identification information of a dispenser using the private key of the second subsequent certificate authority.

2. The hydrogen fueling communication method of claim 1, further comprising:
performing a handshake of transport layer security (TLS) with at least one entity of a hydrogen infrastructure to which the hydrogen fueling operator belongs.

3. The hydrogen fueling communication method of claim 1, further comprising:
generating, by the dispenser using a private key thereof, a dispenser certificate using the dispenser leaf certificate.

4. The hydrogen fueling communication method of claim 3, wherein the dispenser certificate includes, as an issuer, an HFO subsequent certificate authority of a vehicle-to-device (V2D) root certificate authority.

5. The hydrogen fueling communication method of claim 3, wherein an issuer signature of the dispenser certificate is verified using a public key of the second subsequent certificate authority.

6. The hydrogen fueling communication method of claim 2, further comprising:
encrypting a message using a private key of the dispenser and a public key of a receiver being a hydrogen fueled mobility or a user of the hydrogen fueled mobility, encrypting the private key of the dispenser using the public key of the receiver, and transmitting the encrypted message and the encrypted private key to the receiver.

7. The hydrogen fueling communication method of claim 2, further comprising:
mutually authenticating the hydrogen fueled mobility and the dispenser using a certificate of the hydrogen fueled mobility in the performing of the handshake.

8. The hydrogen fueling communication method of claim 7, wherein the certificate of the hydrogen fueled mobility comprises an OEM (original equipment manufacturer) provisioning certificate.

9. The hydrogen fueling communication method of claim 8, wherein the OEM provisioning certificate is issued by an OEM subordinate certification authority that has received an OEM subordinate certificate, such that the OEM provisioning certificate includes a signature value generated by signing a public key and identification information of the hydrogen fueled mobility using a private key of the OEM subordinate certification authority and the signed information; and
wherein the OEM subordinate certificate is issued by an OEM root certification authority such that the OEM subordinate certificate includes a signature value generated by signing a public key and identification information of the OEM subordinate certification authority using a private key of the OEM root certification authority and the signed information.

10. The hydrogen fueling communication method of claim 8, wherein a public key of the OEM provisioning certificate is used by the hydrogen fueled mobility to verify an issuer signature of the second subsequent certificate authority.

11. The hydrogen fueling communication method of claim 1, further comprising:
verifying validity of a counterpart certificate by at least one entity of the hydrogen infrastructure including the dispenser and the hydrogen fueled mobility, using an online certificate status protocol (OCSP) or a certificate revocation list (CRL).

12. A hydrogen fueling communication method by a hydrogen fueled mobility, comprising:
requesting installation of certificate in a hydrogen fueling operator (HFO) or a dispenser belonging to the HFO in a hydrogen infrastructure; and
receiving an OEM provisioning certificate issued by an original equipment manufacturer (OEM) belonging to the hydrogen infrastructure, wherein the receiving of the OEM provisioning certificate, comprises:
generating, by an OEM root certificate authority, an OEM first subordinate certificate including a signature value and signed information by signing a public key and identification information of a first OEM subsequent certificate authority using the OEM root certificate authority's private key;
generating, by the first OEM subsequent certificate authority, an OEM second subordinate certificate including a signature value and signed information by signing a public key and identification information of a second OEM subsequent certificate authority using the first OEM subsequent certificate authority's private key; and
issuing, by the second OEM subsequent certificate authority, the OEM provisioning certificate including a signature value and signed information by signing a public key and identification information of the hydrogen fueled mobility using the second OEM subsequent certificate authority's private key.

13. The hydrogen fueling communication method of claim 12, further comprising:
performing a transport layer security (TLS) handshake with at least one entity of the hydrogen infrastructure including the dispenser.

14. The hydrogen fueling communication method of claim 12, wherein the dispenser possesses a dispenser certificate, and the dispenser certificate is generated using the dispenser leaf certificate and a private key of the dispenser.

15. The hydrogen fueling communication method of claim 14, wherein the dispenser certificate includes, as an issuer, an HFO subsequent certificate authority of a vehicle-to-device (V2D) root certificate authority.

16. The hydrogen fueling communication method of claim 14, wherein an issuer signature of the dispenser certificate is verified using a public key of the second OEM subsequent certificate authority.

17. An apparatus using a hydrogen fueling communication method, comprising:
a processor; and
at least one instruction loaded on the processor,
wherein the at least one instruction causes the processor to perform:
receiving, from an upper root server, a first subordinate certificate that includes a signature value and signed information, the signature value generated by signing a public key and identification information of a first subsequent certificate authority of the HFO using a private key of the upper root server;
generating, by the first subsequent certificate authority, a second subordinate certificate that includes a signature value and signed information, the signature value generated by signing a public key and identification information of a second subsequent certificate authority using the private key of the first subsequent certificate authority; and
issuing, by the second subsequent certificate authority, a dispenser leaf certificate that includes a signature value and signed information, the signature value generated by signing a public key and identification information of a dispenser using the private key of the second subsequent certificate authority.

18. The apparatus of claim 17, wherein the processor further performs:
a handshake of transport layer security (TLS) with at least one entity of the hydrogen infrastructure to which the HFO belongs,
wherein the handshake includes mutual authentication between the dispenser and the hydrogen fueled mobility using a certificate of the hydrogen fueled mobility.

19. The apparatus of claim 17, wherein the processor further performs:
generating a dispenser certificate using the dispenser leaf certificate and a private key of the dispenser,
wherein the dispenser certificate includes, as an issuer, an HFO subsequent certificate authority of a vehicle-to-device (V2D) root certificate authority, and
an issuer signature of the dispenser certificate is verified using a public key of the second subsequent certificate authority.

20. The apparatus of claim 17, wherein the processor further performs either:
encrypting a message using a private key of the dispenser and a public key of a receiver being a hydrogen fueled mobility, encrypting the private key of the dispenser using the public key of the receiver, and transmitting the encrypted private key together with the encrypted message to the hydrogen fueled mobility; or
verifying validity of a counterpart certificate using an online certificate status protocol (OCSP) or a certificate revocation list (CRL).
